(19) United States
(12) Patent Application Publication
(10) Pub. No.: US 2024/0183687 A1
(43) Pub. Date: Jun. 6, 2024

(54) SENSING DEVICE

(71) Applicant: TOYO AUTOMATION CO., LTD., TAINAN CITY (TW)

(72) Inventors: KUN-CHENG TSENG, TAINAN CITY (TW); YUAN-TSUNG LO, TAINAN CITY (TW); YI-AN CHEN, TAINAN CITY (TW); FONG-TING YAN, TAINAN CITY (TW)

(21) Appl. No.: 18/179,508

(22) Filed: Mar. 7, 2023

(30) Foreign Application Priority Data
Dec. 2, 2022 (TW) 111146389

(51) Int. Cl. G01D 5/14

(52) U.S. Cl. CPC G01D 5/14

(57) ABSTRACT

A sensing device includes a driving unit, a magnetic transmission unit, a sensing unit, and an operating unit. The magnetic transmission unit includes a main driving wheel, and first and second driven wheels. The main driving wheel includes a main driving wheel body sleeved co-rotatably to the driving unit, a main feedback portion mounted co-rotatably on the main driving wheel body, and a main magnetic driving portion mounted co-rotatably on the main driving wheel body. The first and second driven wheels respectively include first and driven wheel bodies, first and second feedback portions that are mounted co-rotatably and respectively on the first and second driven wheel bodies, and first and second magnetic driven portions mounted co-rotatably and respectively on the first and second driven wheel bodies, and magnetically driven by the main magnetic driving portion to rotate when the main driving wheel body co-rotates with the driving unit.

### CROSS-REFERENCE TO RELATED APPLICATION

This application claims priority to Taiwanese Invention Patent Application No. 111146389, filed on Dec. 2, 2022.

### FIELD

The disclosure relates to a sensing device, and more particularly to a sensing device including a magnetic transmission unit.

### BACKGROUND

A conventional motor includes a motor unit that includes a spindle and a motor body, a driving gear that is mounted to the spindle, two driven gears that mesh with the driving gear, a rotary encoder, and a controller that is electrically connected to the rotary encoder and the motor body. The rotary encoder has three disks co-rotatable respectively with the driving gear and the two driven gears, three light emitting elements respectively facing the disks and emitting lights, and three sensor sets respectively facing the disks such that each of the disks is disposed between the respective one of the light emitting elements and the respective one of the sensor sets. Each of the disks includes a plurality of coding regions that are transparent and a plurality of coding regions that are opaque arranged alternately. Each of the sensor sets has two spaced-apart sensing components that are configured to sense the light emitted from a corresponding one of the light emitting elements through the respective one of the disks and that respectively output two phase signals having a phase difference of 90 degrees.

The spindle of the conventional motor is driven to rotate by the motor body, and the driving gear co-rotates with the spindle for driving rotation of the driven gears therewith. The sensor sets respectively sense rotations of the disks to output the phase signals, which are then received by the controller. The controller is configured to determine a number of revolutions of each of the driving gear and the driven gears based on the phase signals that change with time and to control operations of the conventional motor.

However, since rotational power from the spindle is transmitted to the driven gears through physical connection among the driving gear and the driven gears, precise manufacturing of the driving gear and the driven gears is required, and the driving gear and the driven gears may be worn out after a period of use. Furthermore, position of the driving gear relative to each of the driven gears is limited since the driving gear would always mesh with the driven gears to transmit the rotational power, so flexibility in arranging the driving gear and the driven gears is limited. In a case where the driving gear and the driven gears are not manufactured precisely or are worn out, the sensor sets may not be able to obtain numbers of revolutions accurately.

### SUMMARY

Therefore, an object of the disclosure is to provide a sensing device that can alleviate at least one of the drawbacks of the prior art. According to the disclosure, a sensing device includes a driving unit, a magnetic transmission unit, a sensing unit, and an operating unit. The driving unit includes a mounting seat, a driving body that is mounted to the mounting seat, and a spindle that extends into the mounting seat, that has a driving end connected to the driving body and a connecting end opposite to the driving end, and that is driven rotatably by the driving body. The magnetic transmission unit includes a main driving wheel, a first driven wheel, and a second driven wheel. The main driving wheel includes a main driving wheel body that is sleeved co-rotatably on the connecting end of the spindle, a main feedback portion that is mounted co-rotatably on the main driving wheel body and that is opposite to the mounting seat, and a main magnetic driving portion that is mounted co-rotatably on the main driving wheel body. The first driven wheel includes a first driven wheel body that is rotatably mounted to the mounting seat, a first feedback portion that is mounted co-rotatably on the first driven wheel body, and a first magnetic driven portion that is mounted co-rotatably on the first driven wheel body and that is magnetically driven by the main magnetic driving portion to rotate relative to the mounting seat when the main driving wheel body co-rotates with the spindle. The second driven wheel includes a second driven wheel body that is rotatably mounted to the mounting seat, a second feedback portion that is mounted co-rotatably to the second driven wheel body, and a second magnetic driven portion that is mounted co-rotatably to the second driven wheel body and that is magnetically driven by the main magnetic driving portion to rotate relative to the mounting seat when the main driving wheel body co-rotates with the spindle. The sensing unit includes a sensing substrate, a main sensor set, a first sensor set, and a second sensor set. The sensing substrate is spaced apart from the main driving wheel, the first driven wheel, and the second driven wheel. The main sensor set is disposed on the sensing substrate, faces and is adjacent to the main feedback portion, and is configured to sense rotation of the main feedback portion and output a main sensing signal indicating the same. The first sensor set is disposed on the sensing substrate, faces and is adjacent to the first feedback portion, and is configured to sense rotation of the first feedback portion and output a first sensing signal indicating the same. The second sensor set is disposed on the sensing substrate, faces and is adjacent to the second feedback portion, and is configured to sense rotation of the second feedback portion and output a second sensing signal indicating the same. The operating unit is electrically connected to the main sensor set, the first sensor set, and the second sensor set for receiving the main sensing signal, the first sensing signal, and the second sensing signal and calculating a number of revolutions of the main driving wheel body based on the main sensing signal, the first sensing signal, and the second sensing signal.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly exploded perspective view of a sensing device of an embodiment according to the present disclosure.

FIG. 2 is a partly exploded perspective view of the embodiment.

FIG. 3 is a schematic front view of a magnetic transmission unit of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently e.g., rotated 90 degrees or at other orientations and the spatially relative terms used herein may be interpreted accordingly.

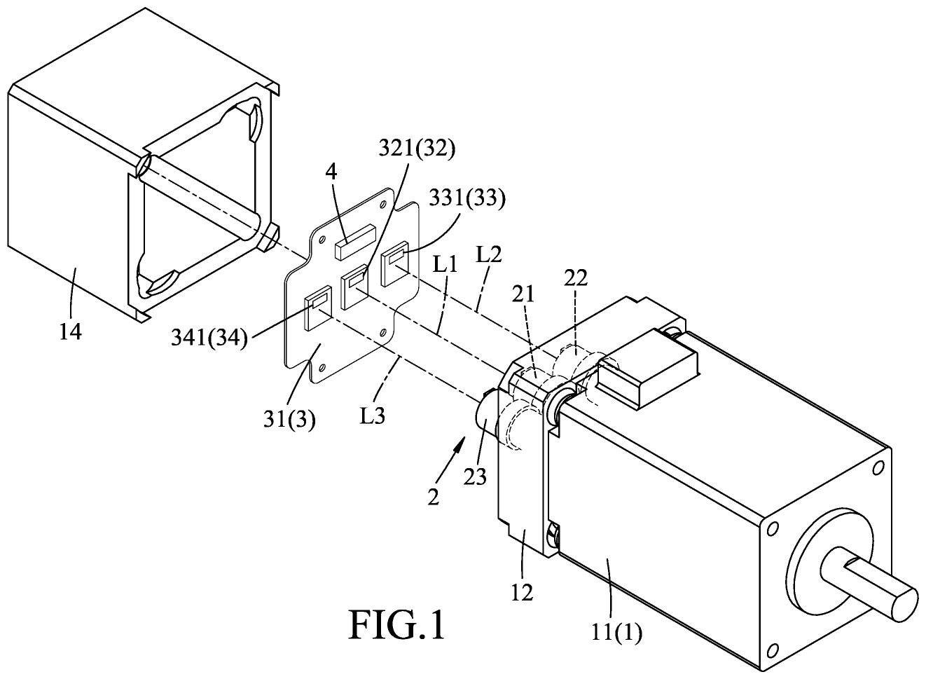

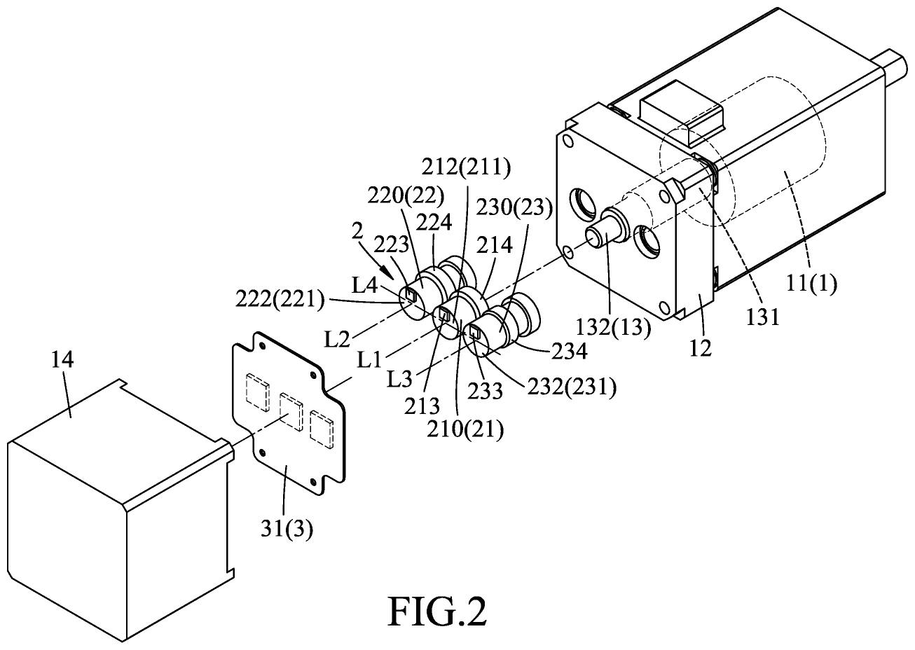

Referring to FIGS. 1 and 2, a sensing device of an embodiment according to the present disclosure includes a driving unit 1, a magnetic transmission unit 2, a sensing unit 3, and an operating unit 4.

The driving unit 1 includes a mounting seat 12, a driving body 11 that is mounted to the mounting seat 12, a spindle 13 that extends into the mounting seat 12, and a packaging housing 14 that is mounted to the mounting seat 12. The packaging housing 14 cooperates with the mounting seat 12 to encapsulate the driving body 11, the spindle 13, the magnetic transmission unit 2, and the sensing unit 3 therein. The spindle 13 is driven by the driving body 11 to rotate, and has a driving end 131 connected to the driving body 11, and a connecting end 132 opposite to the driving end 131 and driven rotatably by the driving body 11.

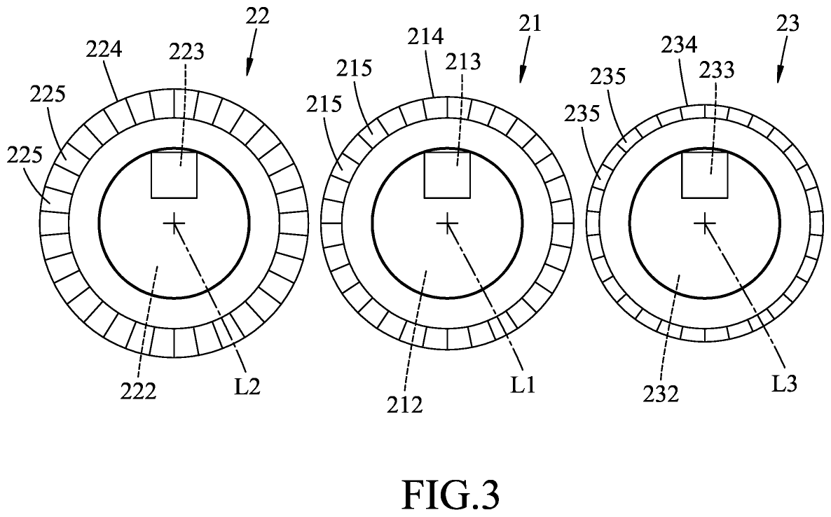

Further referring to FIG. 3, the magnetic transmission unit 2 is a non-contact transmission unit and includes a main driving wheel 21, a first driven wheel 22, and a second driven wheel 23.

The main driving wheel 21 is rotatable about a main axis (L1), and includes a main driving wheel body 210 that is sleeved rotatably on the connecting end 132 of the spindle 13, a main feedback portion 211 that is mounted co-rotatably on the main driving wheel body 210, and a main magnetic driving portion 214 that is mounted co-rotatably on the main driving wheel body 210. The main feedback portion 211 includes a main magnetic surface 212 that is substantially transverse to the main axis (L1), and a main magnetic member 213 that is disposed on the main magnetic surface 212, that is deviated from the main axis (L1), and that is configured to generate a main magnetic field. The main magnetic driving portion 214 includes a plurality of main magnetic poles 215 surrounding the main driving wheel body 210 and disposed fixedly to the main driving wheel body 210 around the main axis (L1). Any two adjacent ones of the main magnetic poles 215 are magnetically opposite to each other. In this embodiment, a number of the main magnetic poles 215 is 32.

The first driven wheel 22 is rotatable about a first axis (L2), and includes a first driven wheel body 220 that is rotatably mounted to the mounting seat 12, a first feedback portion 221 that is mounted co-rotatably on the first driven wheel body 220, and a first magnetic driven portion 224 that is mounted co-rotatably on the first driven wheel body 220 and that is magnetically driven by the main magnetic driving portion 214 to rotate relative to the mounting seat 12 when the main driving wheel body 210 co-rotates with the spindle 13. The first feedback portion 221 includes a first magnetic surface 222 that is substantially transverse to the first axis (L2), and a first magnetic member 223 that is disposed on the first magnetic surface 222, that is deviated from the first axis (L2), and that is configured to generate a first magnetic field. The first magnetic driven portion 224 includes a plurality of first magnetic poles 225 surrounding the first driven wheel body 220 and disposed fixedly to the first driven wheel body 220 around the first axis (L2). Any two adjacent ones of the first magnetic poles 225 are magnetically opposite to each other. A number of the first magnetic poles 225 is greater than that of the main magnetic poles 215. In this embodiment, the number of the first magnetic poles 225 is 34.

The second driven wheel 23 is rotatable about a second axis (L3), and includes a second driven wheel body 230 that is rotatably mounted to the mounting seat 12, a second feedback portion 231 that is mounted co-rotatably on the second driven wheel body 230, and a second magnetic driven portion 234 that is mounted co-rotatably on the second driven wheel body 230 and that is magnetically driven by the main magnetic driving portion 214 to rotate relative to the mounting seat 12 when the main driving wheel body 210 co-rotates with the spindle 13. The second feedback portion 231 includes a second magnetic surface 232 that is substantially transverse to the second axis (L3), and a second magnetic member 233 that is disposed on the second magnetic surface 232, that is deviated from the second axis (L3), and that is configured to generate a second magnetic field. The second magnetic driven portion 234 includes a plurality of second magnetic poles 235 surrounding the second driven wheel body 230 and disposed fixedly to the second driven wheel body 230 around the second axis (L3), Any two adjacent ones of the second magnetic poles 235 are magnetically opposite to each other. A number of the second magnetic poles 235 is smaller than that of the main magnetic poles 215. In this embodiment, the number of the second magnetic poles 235 is 30.

As can be seen in FIG. 3, in this embodiment, the main magnetic driving portion 214 is spaced apart from the first magnetic driven portion 224 and the second magnetic driven portion 234, and drives the first magnetic driven portion 224 and the second magnetic driven portion 234 to rotate by magnetic force. A minimum distance between the main magnetic driving portion 214 and the first magnetic driven portion 224 is substantially the same as a minimum distance between the main magnetic driving portion 214 and the second magnetic driven portion 234. In this embodiment, the minimum distance between the main magnetic driving portion 214 and the first magnetic driven portion 224 is substantially 0.5 mm, and the minimum distance between the main magnetic driving portion 214 and the second magnetic driven portion 234 is substantially 0.5 mm. Each of the main magnetic poles 215 has a main arc length in a circumferential direction of the main driving wheel body 210, each of the first magnetic poles 225 has a first arc length in a circumferential direction of the first driven wheel body 220, and each of the second magnetic poles 235 has a second arc length in a circumferential direction of the second driven wheel body 230. The main arc length, the first arc length, and the second arc length are substantially the same.

In this embodiment, the main axis (L1), the first axis (L2), and the second axis (L3) are substantially parallel to one another. The first driven wheel 22, the main driving wheel 21, and the second driven wheel 23 are arranged sequentially and spaced apart from one another along an arrangement axis (L4) that is transverse to the main axis (L1), the first axis (L2), and the second axis (L3). In this embodiment, the main driving wheel 21 is disposed between the first driven wheel 22 and the second driven wheel 23.

Referring back to FIGS. 1 and 2, the sensing unit 3 includes a sensing substrate 31, a main sensor set 32, a first sensor set 33, and a second sensor set 34. The sensing substrate 31 is spaced apart from the main driving wheel 21, the first driven wheel 22, and the second driven wheel 23 in a direction of the main axis (L1). The main sensor set 32 is disposed on the sensing substrate 31, faces and is adjacent to the main feedback portion 211, and is configured to sense the main magnetic field generated by the main magnetic member 213 of the main feedback portion 211 and thus sense rotation of the main feedback portion 211, and output a main sensing signal indicating the same. The first sensor set 33 is disposed on the sensing substrate 31, faces and is adjacent to the first feedback portion 221, and is configured to sense the first magnetic field generated by the first magnetic member 223 of the first feedback portion 221 and thus sense rotation of the first feedback portion 221, and output a first sensing signal indicating the same. The second sensor set 34 is disposed on the sensing substrate 31, faces and is adjacent to the second feedback portion 231, and is configured to sense the second magnetic field generated by the second magnetic member 233 of the second feedback portion 231 and thus sense rotation of the second feedback portion 231, and output a second sensing signal indicating the same.

The main sensor set 32 includes a main sensor 321 that faces the main magnetic surface 212, that is deviated from the main axis (L1), and that is configured to sense the main magnetic field generated by the main magnetic member 213 when the main magnetic member 213 approaches the main sensor 321 during rotation of the main feedback portion 211 such that the main sensor set 32 outputs the main sensing signal accordingly. Specifically, when the main magnetic member 213 rotates about the main axis (L1) for 360 degrees, the main magnetic member 213 approaches the main sensor 321 for once. In this embodiment, the main magnetic field generated by the main magnetic member 213 is an analog signal and the main magnetic sensor 321 of the main sensor set 32 converts the main magnetic field generated by the main magnetic member 213 into the main sensing signal, e.g., a digital signal.

The first sensor set 33 includes a first magnetic sensor 331 that faces the first magnetic surface 222, that is deviated from the first axis (L2), and that is configured to sense the first magnetic field generated by the first magnetic member 223 when the first magnetic member 223 approaches the first sensor 331 during rotation of the first feedback portion 221 such that the first sensor set 33 outputs the first sensing signal. Specifically, when the first magnetic member 223 rotates about the first axis (L2) for 360 degrees, the first magnetic member 223 approaches the first sensor 331 for once. In this embodiment, the first magnetic field generated by the first magnetic member 223 is an analog signal and the first magnetic sensor 331 of the first sensor set 33 converts the first magnetic field generated by the first magnetic member 233 into the first sensing signal, e.g., a digital signal.

The second sensor set 34 includes a second magnetic sensor 341 that faces the second magnetic surface 232, that is deviated from the second axis (L2), and that is configured to sense the second magnetic field generated by the second magnetic member 233 when the second magnetic member 233 approaches the second sensor 341 during rotation of the second feedback portion 231 such that the second sensor set 34 outputs the second sensing signal. Specifically, when the second magnetic member 233 rotates about the second axis (L3) for 360 degrees, the second magnetic member 233 approaches the second sensor 341 for once. In this embodiment, the second magnetic field generated by the second magnetic member 233 is an analog signal and the second magnetic sensor 341 of the second sensor set 34 converts the second magnetic field generated by the second magnetic member 233 into the second sensing signal, e.g., a digital signal.

The operating unit 4 is electrically connected to the main sensor set 32, the first sensor set 33, and the second sensor set 34 for receiving the main sensing signal, the first sensing signal, and the second sensing signal, and calculates a number of revolutions of the main driving wheel body 210 based on the main sensing signal, the first sensing signal, and the second sensing signal. The operating unit 4 includes a microcontroller or a controller such as, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

In actual operation, the driving body 11 drives rotation of the spindle 13 at a constant speed, and the main driving wheel 21 is driven to co-rotate with the spindle 13 about the spindle axis (L1). By virtue of the arrangement of the main magnetic poles 215 of the main magnetic driving portion 214 in which any two adjacent ones of the main magnetic poles 215 are magnetically opposite to each other and the similar arrangement of the first magnetic driving portion 224 and the second magnetic driving portion 234, the first magnetic driving portion 224 and the second magnetic driving portion 234 are driven to rotate by the main magnetic driving portion 214 by magnetic attractive force and/or magnetic repulsive force.

Once the main magnetic member 213 starts to rotate about the main axis (L1), the first magnetic member 223 is driven to rotate about the first axis (L2), and the second magnetic member 233 is driven to rotate about the second axis (L3). The main magnetic sensor 321, the first magnetic sensor 331, and the second magnetic sensor 341 convert the magnetic field generated by the main magnetic member 213, the first magnetic member 223, and the second magnetic member 233 into the main sensing signal, the first sensing signal, and the second sensing signal, respectively. Then, the operating unit 4 receives the main sensing signal, the first sensing signal, and the second sensing signal to calculate the number of revolutions of the main driving wheel body 210.

By virtue of the design of the radius and thus the perimeter of the main driving wheel 21, the first driven wheel 22 and the second driven wheel 23 that are different from one another, the number of the first magnetic poles 225 which is greater than that of the main magnetic poles 215, and the number of the second magnetic poles 235 which is smaller than that of the main magnetic poles 215, the operating unit 4 may further configured to calculate a number of revolutions of the main driving wheel body 210 more accurately after obtaining the number of revolutions of the main driving wheel body 210 based on the number of revolutions of the first driven wheel body 220 and the second driven wheel body 230. Specifically, because of the main arc length, the first arc length, and the second arc length are substantially the same, a distance that each of the main magnetic member 213, the first magnetic member 223, and the second magnetic member 233 moves in the circumferential direction of the respective one of the main driving wheel body 210, the first driven wheel body 220, and the second driven wheel body 230 is supposed to be identical. The number of revolutions of the main driving wheel body 210 may be estimated more accurately based on the number of the first magnetic poles 225 and the second magnetic poles 235. In a case where the number of the revolutions of each of the main driving wheel body 210, the first driven wheel body 220, and the second wheel body 230 ranges from 5 to 6, an estimated distance that each of the main magnetic member 213, the first magnetic member 223, and the second magnetic member 233 moves, which is referred to as main, first and second estimated distance in the following description, is calculated by multiplying the number of each of the main magnetic poles 215, the first magnetic poles 225, and the second magnetic poles 235 with their respective number of revolutions. Thus, the main estimated distance ranges from 160 (i.e., 32×5) to 191 (i.e., 32×6−1), the first estimated distance ranges from 170 (i.e., 34×5) to 203 (i.e., 34×6−1), and the second estimated distance ranges from 150 (i.e., 30×5) to 179 (i.e., 30×6−1). The main estimated distance is limited between the minimum value of the first estimated distance and the maximum value of the second estimated distance, i.e., ranging from 170 to 179. Therefore, the number of revolutions of the main driving wheel 21 is calculated by dividing the main estimated distance by the number of the main poles 215 and thus ranges from 5.31 (i.e., 170/32) to 5.59 (i.e., 179/32). In this way, the number of revolutions of the main driving wheel 21 thus obtained is more accurate.

It should be noted that a maximum number of revolutions of the main driving wheel body 210 that can be calculated by the operating unit 4 is equal to the least common multiple of the numbers of the first magnetic poles 225 and the second magnetic poles 235. In this embodiment, the number of the first magnetic poles 225 is 34, the number of the second magnetic poles 235 is 30, and the least common multiple of 34 and 30 is 510, so the maximum number of revolutions of the main driving wheel body 210 is equal to 510. In a case where the main driving wheel 21 rotates for more than 510 revolutions, permutation of the first driven wheel 22 and the second driven wheel 23 is repeated and the number of revolutions of the main driving wheel 21 may not be estimated accurately based on the number of revolutions of each of the first driven wheel 22 and the second driven wheel 23. In other words, when rotation of the main driving wheel 21 is within 510 cycles, a more accurate number of revolutions of the main driving wheel 21 may be obtained. It should be noted that the present disclosure is not limited to the example described above and a person having ordinary skill in the art may modify the embodiment as required.

By virtue of the magnetic transmission unit 2, the sensing unit 3, and the operating unit 4, an incremental rotary encoder and/or an absolute rotary encoder may be realized so the number of revolutions of the main driving wheel 21 may be calculated more accurately.

The effects of the sensing device of the present disclosure are described in the following.

First, the arrangements of the main magnetic driving portion 214, the first magnetic driven portion 224, and the second magnetic driven portion 234 that are mounted co-rotatably and respectively on the main driving wheel body 210, the first driven wheel body 220, and the second driven wheel body 230 enable the main driving wheel 21 to drive the first driven wheel 22 and the second driven wheel 23 magnetically without physical contact to transmit rotational power from the spindle 13. Thus, as compared to a conventional gear transmission, the position of the main driving wheel body 210 relative to the first driven wheel body 220 and the second driven wheel body 230, e.g., the minimum distance between the main magnetic driving portion 214 and each of the first magnetic driven portion 224 and the second magnetic driven portion 234 may be modified to suit different requirements and is thus more flexible. Furthermore, the magnetic transmission unit 2 would not be worn after a period of use because the first driven wheel body 220 and the second driven wheel body 230 are driven in a non-contact manner, and thus the embodiment is suitable to be used in a scenario with a relative high operating speed, e.g., 10000 revolutions per minute (rpm).

Second, by virtue of the first driven wheel 22, the main driving wheel 21, and the second driven wheel 23 being sequentially arranged along the arrangement axis (L4), and the minimum distance between the main magnetic driving portion 214 and each of the first magnetic driven portion 224 and the second magnetic driven portion 234 being 0.5 mm, rotational power from the spindle 13 may be effectively transmitted to the first magnetic driven portion 224 and the second magnetic driven portion 234, and may not be dispersed easily to thereby obtain a relatively good transmission efficiency.

In summary, the present disclosure not only permits adjustment of the minimum distance between the main driving wheel 21 and each of the first driven wheel 22 and the second driven wheel 23, but also reduces wear and transmission loss of the magnetic transmission unit 2 so the object of this disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A sensing device, comprising:
a driving unit including
a mounting seat,
a driving body that is mounted to said mounting seat, and
a spindle that extends into said mounting seat, that has a driving end connected to said driving body and a connecting end opposite to said driving end, and that is driven rotatably by said driving body;
a magnetic transmission unit including
a main driving wheel that includes
a main driving wheel body sleeved co-rotatably on said connecting end of said spindle,
a main feedback portion mounted co-rotatably on said main driving wheel body, and
a main magnetic driving portion mounted co-rotatably on said main driving wheel body,
a first driven wheel that includes
a first driven wheel body rotatably mounted to said mounting seat
a first feedback portion mounted co-rotatably on said first driven wheel body, and
a first magnetic driven portion mounted co-rotatably on said first driven wheel body and being magnetically driven by said main magnetic driving portion to rotate relative to said mounting seat when said main driving wheel body co-rotates with said spindle, and
a second driven wheel that includes
a second driven wheel body rotatably mounted to said mounting seat,
a second feedback portion mounted co-rotatably to said second driven wheel body, and
a second magnetic driven portion mounted co-rotatably to said second driven wheel body and being magnetically driven by said main magnetic driving portion to rotate relative to said mounting seat when said main driving wheel body co-rotates with said spindle;
a sensing unit including
a sensing substrate that is spaced apart from said main driving wheel, said first driven wheel and said second driven wheel,
a main sensor set that is disposed on said sensing substrate, that faces and is adjacent to said main feedback portion, and that is configured to sense rotation of said main feedback portion and output a main sensing signal indicating the same,
a first sensor set that is disposed on said sensing substrate, that faces and is adjacent to said first feedback portion, and that is configured to sense rotation of said first feedback portion and output a first sensing signal indicating the same, and
a second sensor set that is disposed on said sensing substrate, that faces and is adjacent to said second feedback portion, and that is configured to sense rotation of said second feedback portion and output a second sensing signal indicating the same; and
an operating unit electrically connected to said main sensor set, said first sensor set, and said second sensor set for receiving the main sensing signal, the first sensing signal, and the second sensing signal and calculating a number of revolutions of said main driving wheel body based on the main sensing signal, the first sensing signal and the second sensing signal.

2. The sensing device as claimed in claim 1, wherein:
said main magnetic driving portion includes a plurality of main magnetic poles surrounding said main driving wheel body;
said first magnetic driven portion includes a plurality of first magnetic poles surrounding said first driven wheel body, a number of said first magnetic poles being larger than that of said main magnetic poles; and
said second magnetic driven portion includes a plurality of second magnetic poles surrounding said second driven wheel body, a number of said second magnetic poles (235) being smaller than that of said main magnetic poles.

3. The sensing device as claimed in claim 1, wherein:
said main magnetic driving portion is spaced apart from said first magnetic driven portion and said second magnetic driven portion, a minimum distance between said main magnetic driving portion and said first magnetic driven portion being substantially the same as a minimum distance between said main magnetic driving portion and said second magnetic driven portion;
each of said main magnetic poles has a main arc length in a circumferential direction of said main driving wheel body;
each of said first magnetic poles has a first arc length in a circumferential direction of said first driven wheel body; and
each of said second magnetic poles has a second arc length in a circumferential direction of said second driven wheel body, the main arc length, the first arc length and the second arc length substantially being the same.

4. The sensing device as claimed in claim 1, wherein said main driving wheel is rotatable about a main axis, said first driven wheel is rotatable about a first axis, and said second driven wheel is rotatable about a second axis, said main axis, said first axis and said second axis substantially being parallel to one another.

5. The sensing device as claimed in claim 4, wherein:
said first driven wheel, said main driving wheel, and said second driven wheel are spaced apart from one another along an arrangement axis that is transverse to said main axis, said first axis, and said second axis; and
said main driving wheel is disposed between said first driven wheel and said second driven wheel.

6. The sensing device as claimed in claim 1, wherein:
said main feedback portion includes a main magnetic surface, and a main magnetic member that is disposed on said main magnetic surface and that is configured to generate a main magnetic field to be sensed by said main sensor set such that said main sensor set outputs the main sensing signal indicating the main magnetic field of said main magnetic member;
said first feedback portion includes a first magnetic surface, and a first magnetic member that is disposed on said first magnetic surface and that is configured to generate a first magnetic field to be sensed by said first sensor set such that said first sensor set outputs the first sensing signal indicating the first magnetic field of said first magnetic member; and
said second feedback portion includes a second magnetic surface, and a second magnetic member that is disposed on said second magnetic surface and that is configured to generate a second magnetic field to be sensed by said second sensor set such that said second sensor set outputs the second sensing signal indicating the second magnetic field of said second magnetic member.

7. The sensing device as claimed in claim 6, wherein:
said main sensor set includes a main sensor that faces said main magnetic surface, and that is configured to sense the main magnetic field generated by said main magnetic member when said main magnetic member approaches said main sensor during rotation of said main feedback portion such that said main sensor set outputs the main sensing signal accordingly;
said first sensor set includes a first sensor that faces said first magnetic surface, and that is configured to sense the first magnetic field generated by said first magnetic member when said first magnetic member approaches said first sensor during rotation of said first feedback portion such that said first sensor set outputs the first sensing signal accordingly; and
said second sensor set includes a second sensor that faces said second magnetic surface, and that is configured to sense the second magnetic field generated by said second magnetic member when said second magnetic member approaches said second sensor during rotation of said second feedback portion such that said second sensor set outputs the second sensing signal accordingly.

8. The sensing device as claimed in claim 4, wherein:
said main sensor set includes a main sensor that is deviated from the main axis, said first sensor set includes a first sensor that is deviated from the first axis, and said second sensor set includes a second sensor that is deviated from the second axis;
said main feedback portion includes a main magnetic surface that faces said main sensor, and a main magnetic member that is disposed on said main magnetic surface, that is deviated from the main axis, and that is configured to generate a main magnetic field to be sensed by said main sensor when said main magnetic member approaches said main sensor during rotation of said main feedback portion such that said main sensor set outputs the main sensing signal accordingly;
said first feedback portion includes a first magnetic surface that faces said first sensor, and a first magnetic member that is disposed on said first magnetic surface, that is deviated from the first axis, and that is configured to generate a first magnetic field to be sensed by said first sensor when said first magnetic member approaches said first sensor during rotation of said first feedback portion such that said first sensor set outputs the first sensing signal accordingly; and
said second feedback portion includes a second magnetic surface that faces said second sensor, and a second magnetic member that is disposed on said second magnetic surface, that is deviated from the second axis, and that is configured to generate a second magnetic field to be sensed by said second sensor when said second magnetic member approaches said second sensor during rotation of said second feedback portion such that said second sensor set outputs the second sensing signal accordingly.
